(19) United States
(12) Patent Application Publication
(10) Pub. No.: US 2007/0023976 A1
(43) Pub. Date: Feb. 1, 2007

(54) Imprint lithography

(75) Inventor: Aleksey Yurievich Kolesnychenko, Helmond (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/189,010

(22) Filed: Jul. 26, 2005

(51) Int. Cl. B29C 35/08

(52) U.S. Cl. 264/496; 425/385; 425/174.4

(57) ABSTRACT

A lithographic apparatus is disclosed that has an imprint template and a substrate table configured to hold a substrate, the imprint template having a patterned surface, a layer of heat absorbing material provided on the patterned surface of the imprint template.

### 1. FIELD

The present invention relates to imprint lithography.

### 2. BACKGROUND

A lithographic apparatus is a machine that applies a desired pattern onto a target portion of a substrate. Lithographic apparatus are conventionally used, for example, in the manufacture of integrated circuits (ICs), flat panel displays and other devices involving fine structures.

It is desirable to reduce the size of features in a lithographic pattern because this allows for a greater density of features on a given substrate area. In photolithography, the increased resolution may be achieved by using light of shorter wavelength. However, there are problems associated with such reductions. Current systems are starting to adopt optical sources with wavelengths in the 193 nm regime but even at this level, diffraction limitations become a barrier. At lower wavelengths, the transparency of materials is very poor. Optical lithography machines capable of enhanced resolutions require complex optics and rare materials and are consequently very expensive.

An alternative for printing sub-100 nm features, known as imprint lithography, comprises transferring a pattern to a substrate by imprinting a pattern into an imprintable medium using a physical mould or template. The imprintable medium may be the substrate or a material coated on to a surface of the substrate. The imprintable medium may be functional or may be used as a “mask” to transfer a pattern to an underlying surface. The imprintable medium may, for instance, be provided as a resist deposited on a substrate such as a semiconductor material to which the pattern defined by the template is to be transferred. Imprint lithography is thus essentially a moulding process on a micrometer or nanometer scale in which the topography of a template defines the patterns created on a substrate. Patterns may be layered as with optical lithography processes so that in principle imprint lithography could be used for such applications as IC manufacture.

The resolution of imprint lithography is limited only by the resolution of the template fabrication process. For instance, imprint lithography has been used to produce features in the sub-50 nm range with significantly improved resolution and line edge roughness compared to that achievable with conventional optical lithography processes. In addition, imprint processes do not require expensive optics, advanced illumination sources or specialized resist materials typically required by optical lithography processes.

Current imprint lithography processes potentially do have a number of drawbacks as will be mentioned below, particularly with regard to achieving overlay accuracy and high throughput. However the significant improvements in resolution and line edge roughness attainable from imprint lithography are strong drivers for addressing these and other problems.

When using a thermoplastic or thermosetting imprintable medium, it may be difficult to heat the imprintable medium to a required temperature. This is addressed by one or more embodiments of the present invention.

### 3. SUMMARY

According to a first aspect of the present invention, there is provided a lithographic apparatus comprising an imprint template and a substrate table configured to hold a substrate, the imprint template having a patterned surface, a layer of heat absorbing material provided on the patterned surface of the imprint template.

According to a second aspect of the invention, there is provided an imprint template having a surface with a pattern configured to be imprinted into an imprintable medium, the imprint template comprising a layer of heat absorbing material located over the pattern.

According to a third aspect of the invention, there is provided a method of imprint lithography, the method comprising positioning an imprint template on a layer of imprintable medium on a substrate, such that a layer of heat absorbing material provided on a patterned surface of the imprint template is in contact with the imprintable medium, illuminating the layer of heat absorbing material with radiation such that the layer of heat absorbing material is heated up and transfers heat to the imprintable medium, and pressing the imprint template into the imprintable medium.

One or more embodiments of the present invention are applicable to any imprint lithography process in which a patterned template is imprinted into an imprintable medium in a flowable state, and for instance can be applied to hot imprint lithography as described below. For the purpose of understanding one or more embodiments of the present invention, it is not necessary to describe the imprint process in any more detail than is given below and is known in the art.

Further features of one or more embodiments of the present invention will be apparent from the following description.

### 4. BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1a-1c illustrate examples of conventional soft, hot and UV imprint lithography processes respectively;

FIG. 2 illustrates a two step etching process employed when hot and UV imprint lithography is used to pattern a resist layer;

FIG. 3 schematically illustrates a template and a typical imprintable resist layer deposited on a substrate; and

FIGS. 4a-4e schematically show use of an imprint lithography apparatus according to an embodiment of the invention.

### 5. DETAILED DESCRIPTION

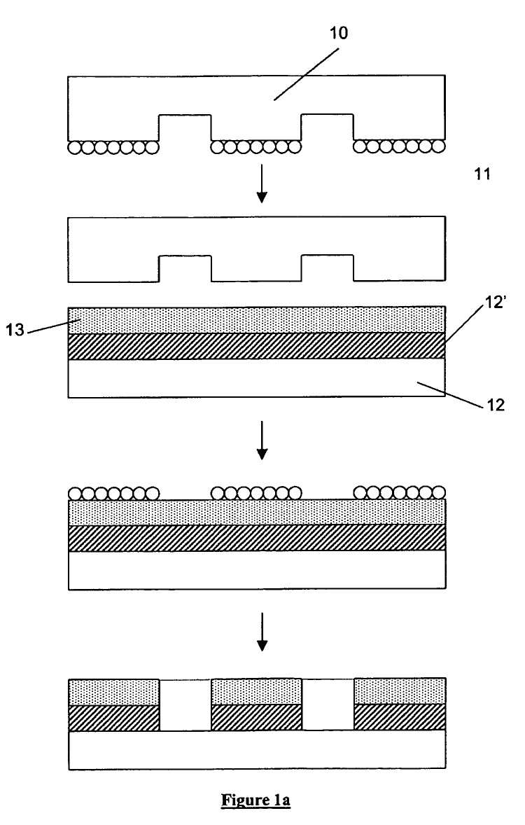

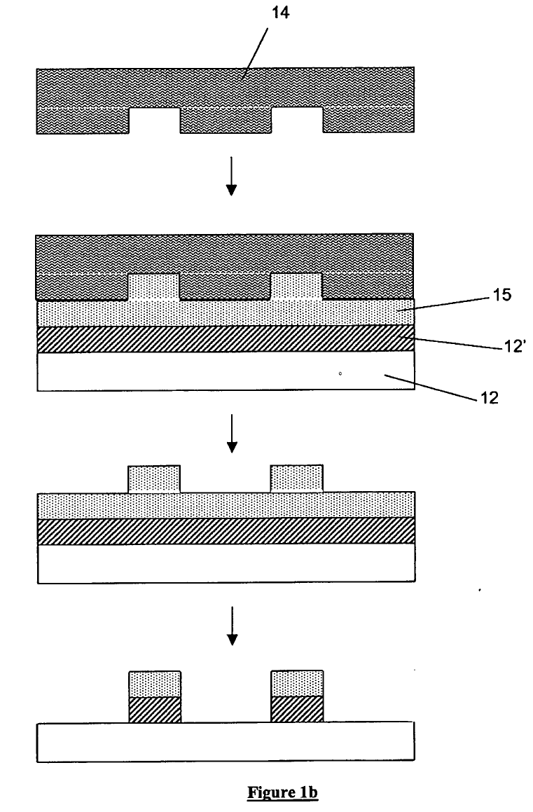

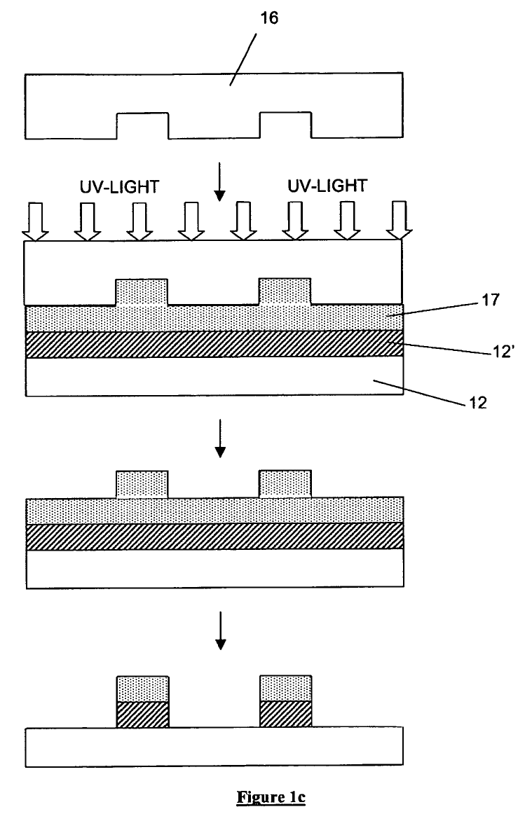

There are two principal approaches to imprint lithography which will be termed generally as hot imprint lithography and UV imprint lithography. There is also a third type of “printing” lithography known as soft lithography. Examples of these are illustrated in FIGS. 1a to 1c.

FIG. 1a shows the soft lithography process which involves transferring a layer of molecules 11 (typically an ink such as a thiol) from a flexible template 10 (typically fabricated from polydimethylsiloxane (PDMS)) onto a resist layer 13 which is supported upon a substrate 12 and planarization and transfer layer 12′. The template 10 has a pattern of features on its surface, the molecular layer being disposed upon the features. When the template is pressed against the resist layer, the layer of molecules 11 stick to the resist. Upon removal of the template from the resist the layer of molecules 11 stick to the resist, the residual layer of resist is etched such that the areas of the resist not covered by the transferred molecular layer are etched down to the substrate.

The template used in soft lithography may be easily deformed and may therefore not be suited to high resolution applications, e.g. on a nanometer scale, since the deformation of the template may adversely affect the imprinted pattern. Furthermore, when fabricating multiple layer structures, in which the same region will be overlaid multiple times, soft imprint lithography may not provide overlay accuracy on a nanometer scale.

Hot imprint lithography (or hot embossing) is also known as nanoimprint lithography (NIL) when used on a nanometer scale. The process uses harder templates made from, for example, silicon or nickel, which are more resistant to wear and deformation. This is described for instance in U.S. Pat. No. 6,482,742 and illustrated in FIG. 1b. In a typical hot imprint process a solid template 14 is imprinted into a thermosetting or a thermoplastic polymer resin 15, which has been cast on the surface of a substrate 12. The resin may for instance be spin coated and baked onto the substrate surface or more typically (as in the example illustrated) onto a planarization and transfer layer 12′. It shall be understood that the term “hard” when describing an imprint template includes materials which may generally be considered between “hard” and “soft” materials, such as for example “hard” rubber. The suitability of a particular material for use as an imprint template is determined by its application requirements.

When a thermosetting polymer resin is used, the resin is heated to a temperature such that, upon contact with the template, the resin is sufficiently flowable to flow into the pattern features defined on the template. The temperature of the resin is then increased to thermally cure (e.g. crosslink) the resin so that it solidifies and irreversibly adopts the desired pattern. The template may then be removed and the patterned resin cooled. Examples of thermoplastic polymer resins used in hot imprint lithography processes are poly(methyl methacrylate), polystyrene, poly(benzyl methacrylate) or poly (cyclohexyl methacrylate). The thermoplastic resin is heated so that it is in a freely flowable state immediately prior to imprinting with the template. It is typically necessary to heat the thermoplastic resin to a temperature considerably above the glass transition temperature of the resin. The template is pressed into the flowable resin and sufficient pressure is applied to ensure the resin flows into all the pattern features defined on the template. The resin is then cooled to below its glass transition temperature with the template in place whereupon the resin irreversibly adopts the desired pattern. The pattern will consist of the features in relief from a residual layer of the resin which may then be removed by an appropriate etch process to leave only the pattern features.

Upon removal of the template from the solidified resin, a two-step etching process is performed as illustrated in FIGS. 2a to 2c. The substrate 20 has a planarization and transfer layer 21 immediately upon it, as shown in FIG. 2a. The purpose of the planarization and transfer layer is twofold. It acts to provide a surface parallel to that of the template, which is important to ensure that the contact between the template and the resin is substantially parallel, and also to improve the aspect ratio of the printed features, as will be described below.

After the template has been removed, a residual layer 22 of the solidified resin is left on the planarization and transfer layer, shaped in the desired pattern. The first etch is isotropic and removes parts of the residual layer, resulting in a poor aspect ratio of features where L1 is the height of the features 23, as shown in FIG. 2b. The second etch is anisotropic (or selective) and improves the aspect ratio. The anisotropic etch removes those parts of the planarization and transfer layer which are not covered by the solidified resin, increasing the aspect ratio of the features 23 to (L2/D), as shown in FIG. 2c. The resulting polymer thickness contrast left on the substrate after etching can be used as, for instance, a mask for dry etching if the imprinted polymer is sufficiently resistant, for instance as a step in a lift-off process.

Hot imprint lithography suffers from a disadvantage in that not only is the pattern transfer performed at a higher temperature, but also relatively large temperature differentials might be required in order to ensure the resin is adequately solidified before the template is removed. Temperature differentials between 35 and 100° C. are known from literature. Differential thermal expansion between, for instance, the substrate and template can then lead to distortion in the transferred pattern. The problem is exacerbated by the relatively high pressures used for the imprinting step which, due the viscous nature of the imprintable materials, can induce mechanical deformation in the substrate, again distorting the pattern.

UV imprint lithography on the other hand does not involve such high temperatures and temperature changes. Nor does it require such viscous imprintable materials. Rather UV imprint lithography involves the use of a transparent template and a UV-curable liquid, typically a monomer such as an acrylate or methacrylate for example. In general any photopolymerizable material could be used, such as a mixture of monomers and an initiator. The curable liquid may also, for instance, include a dimethyl siloxane derivative. Such materials are much less viscous than the thermosetting and thermoplastic resins used in hot imprint lithography and consequently move much faster to fill template pattern features. Low temperature and low pressure operation also favors higher throughput capabilities.

An example of a UV imprint process is illustrated in FIG. 1c. A quartz template 16 is applied to a UV-curable resin 17 in a similar manner to the process of FIG. 1b. Instead of raising the temperature as in hot embossing employing a thermosetting resin, or temperature cycling when using a thermoplastic resin, UV light is applied to the resin through the quartz template in order to polymerize and thus cure it. Upon removal of the template, the remaining steps of etching the residual layer of resist are the same as for the hot embossing process described above. The UV curable resins typically used have a much lower viscosity than typical thermoplastic resins so that lower imprint pressures are used. Reduced physical deformation due to the lower pressures, together with reduced deformation due to high temperatures and temperature changes, makes UV imprint lithography better suited to application requiring high overlay accuracy. In addition the transparent nature of UV imprint templates can accommodate optical alignment techniques simultaneously to the imprint.

Although this type of imprint lithography mainly uses UV curable materials, and is thus generically referred to as UV imprint lithography, other wavelengths of radiation may be used to cure appropriately selected materials (e.g. activate a polymerization or cross linking reaction). In general any radiation capable of initiating such a chemical reaction may be used if an appropriate imprintable material is available. Alternative “activating light” may, for instance, include visible light, infrared light, x-ray radiation and electron beam radiation. In the general description above, and below, references to UV imprint lithography and use of UV light are not intended to exclude these and other activating light possibilities.

As an alternative to imprint systems using a planar template which is maintained substantially parallel to the substrate surface, roller imprint systems have been developed. Both hot and UV roller imprint systems have been proposed in which the template is formed on a roller but otherwise the imprint process is very similar to imprinting using a planar template. Unless the context requires otherwise, references to an imprint template include references to a roller template.

There is a particular development of UV imprint technology known as step and flash imprint lithography (SFIL) which may be used to pattern a substrate in small steps in a similar manner to optical steppers conventionally used in IC manufacture. This involves printing small areas of the substrate at a time by imprinting a template into a UV curable resin, ‘flashing’ UV light through the template to cure the resin beneath the template, removing the template, stepping to an adjacent region of the substrate and repeating the operation. The small field size of such step and repeat processes minimizes pattern distortions (CD variations) so that SFIL is particularly suited to manufacture of IC and other devices requiring high overlay accuracy.

Although in principle the UV curable resin can be applied to the entire substrate surface, for instance by spin coating, this is problematic due to the volatile nature of UV curable resins.

One approach to addressing this problem is the so-called ‘drop on demand’ process in which the resin is dispensed onto a target portion of the substrate in droplets immediately prior to imprinting with the template. The liquid dispensing is controlled so that a certain volume of liquid is deposited on a particular target portion of the substrate. The liquid may be dispensed in a variety of patterns and the combination of carefully controlling liquid volume and placement of the pattern can be employed to confine patterning to the target area.

Dispensing the resin on demand as mentioned is not a trivial matter. The size and spacing of the droplets are carefully controlled to ensure there is sufficient resin to fill template features while at the same time minimizing excess resin which can be rolled to an undesirably thick or uneven residual layer since as soon as neighboring drops touch fluid the resin will have nowhere to flow. The problems associated with overly thick or uneven residual layer are discussed below.

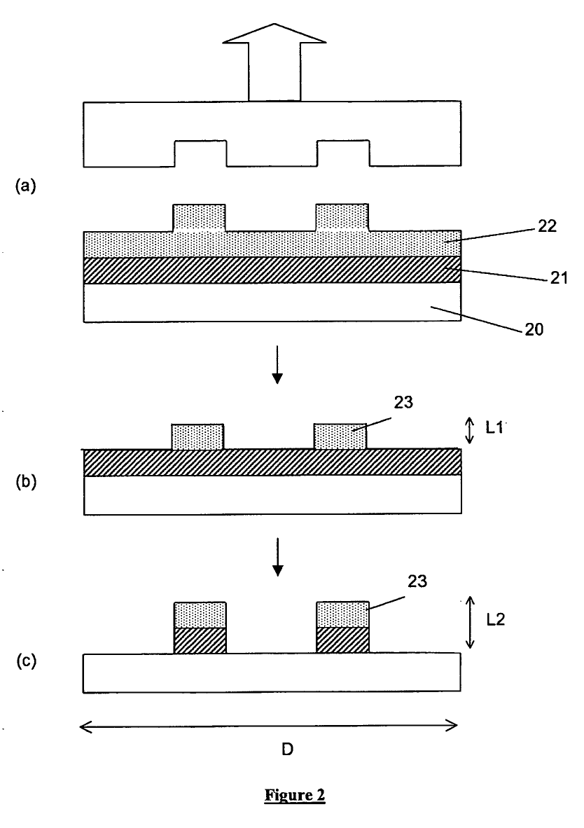

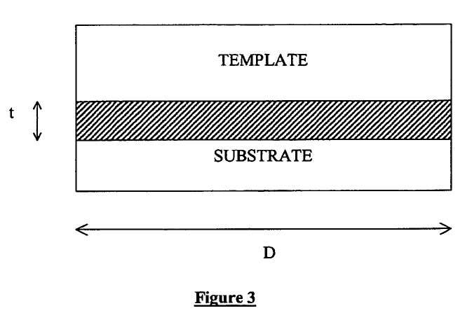

FIG. 3 illustrates the relative dimensions of the template, imprintable material (curable monomer, thermosetting resin, thermoplastic, etc.) and substrate. The ratio of the width of the substrate, D, to the thickness of the curable resin layer, t, is of the order of 10⁶. It will be appreciated that, in order to avoid the features projecting from the template damaging the substrate, the dimension t should be greater than the depth of the projecting features on the template.

The residual layer left after stamping is useful in protecting the underlying substrate, but as mentioned above it is also the source of a number of problems particularly when high resolution and/or overlay accuracy is desired. The first ‘breakthrough’ etch is isotropic (non-selective) and will thus to some extent erode the features imprinted as well as the residual layer. This is exacerbated if the residual layer is overly thick and/or uneven.

This problem can, for instance, lead to variation in the thickness of lines ultimately formed in the underlying substrate (i.e., variation in the critical dimension). The uniformity of the thickness of a line that is etched in the transfer layer in the second anisotropic etch is dependent upon the aspect ratio and integrity of the shape of the feature left in the resin. If the residual resin layer is uneven, then the non-selective first etch can leave some of these features with “rounded” tops so that they are not sufficiently well defined to ensure good uniformity of line thickness in the second and any subsequent etch process.

In principle the above problem can be reduced by ensuring the residual layer is as thin as possible but this can require application of undesirably large pressures (increasing substrate deformation) and relatively long imprinting times (reducing throughput).

The template is a significant component of the imprint lithography system. As noted above, the resolution of the features on the template surface is a limiting factor on the attainable resolution of features printed on the substrate. The templates used for hot and UV lithography are generally formed in a two-stage process. Initially, the desired pattern is written using, for example, electron beam writing, to give a high resolution pattern in resist. The resist pattern is then transferred into a thin layer of chrome which forms the mask for the final, anisotropic etch step to transfer the pattern into the base material of the template. Other techniques such as ion-beam lithography, X-ray lithography, extreme UV lithography, epitaxial growth, thin film deposition, chemical etching, plasma etching, ion etching or ion milling could be used. Generally a technique capable of very high resolution will be preferred as the template is effectively a 1× mask with the resolution of the transferred pattern being limited by the resolution of the pattern on the template.

The release characteristics of the template may also be an important consideration. The template may, for instance, be treated with a surface treatment material to form a thin release layer on the template having a low surface energy (a thin release layer may also be deposited on the substrate).

Although reference is made above to depositing a UV curable liquid onto a substrate, the liquid could also be deposited on the template and in general the same techniques and considerations will apply.

Another consideration in the development of imprint lithography is the mechanical durability of the template. The template is subjected to large forces during stamping of the resist, and in the case of hot lithography, it is also subjected to extremes of pressure and temperature. This will cause wearing of the template, and may adversely affect the shape of the pattern imprinted upon the substrate.

In hot imprint lithography there is a potential advantage in using a template of the same or similar material to the substrate to be patterned in order to minimize differential thermal expansion between the two. In UV imprint lithography, the template is at least partially transparent to the activating light and accordingly quartz templates are used. Although specific reference may be made in this text to the use of imprint lithography in the manufacture of ICs, it should be understood that imprint apparatus and methods described may have other applications, such as the manufacture of integrated optical systems, guidance and detection patterns for magnetic domain memories, hard disc magnetic media, flat panel displays, thin-film magnetic heads, etc.

While in the description above particular reference has been made to the use of imprint lithography to transfer a template pattern to a substrate via an imprintable resin effectively acting as a resist, in some circumstances the imprintable material may itself be a functional material, for instance having a functionally such as conductivity, optical linear or non linear response, etc. For example, the functional material may form a conductive layer, a semiconductive layer, a dielectric layer or a layer having another desirable mechanical, electrical or optical property. Some organic substances may also be appropriate functional materials. Such applications may be within the scope of an embodiment of the present invention.

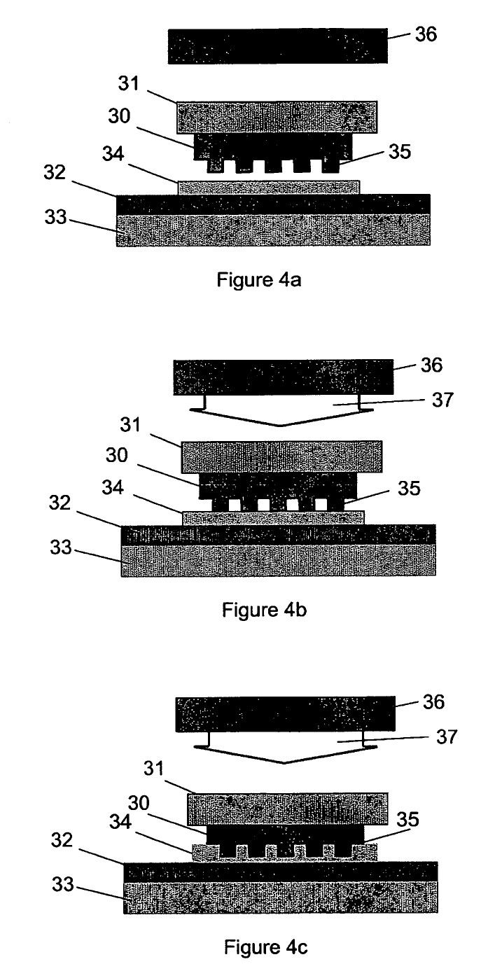

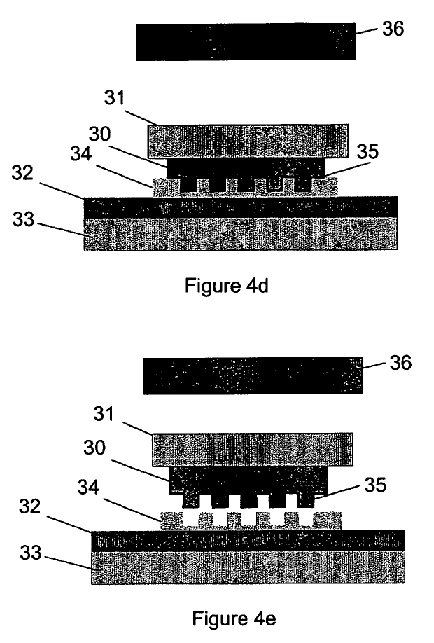

FIG. 4 shows schematically an embodiment of the present invention. Referring to FIG. 4, an imprint template 30 held by a template holder 31 is located above a substrate 32 held by a substrate holder 33. A layer of imprintable medium 34 is provided on an uppermost surface of the substrate 32. A lowermost surface of the imprint template 30 is provided with a pattern (shown schematically as crenellations) for imprinting into the imprintable medium 34. A layer of metal 35 is provided over the pattern on the imprint template 30. The metal may, for example, be nickel or chromium, although other metals may be used. Typically the metal layer 35 will be between a few tens and a few hundreds of nanometers thick. The layer of imprintable medium 34 will be typically a couple of hundred nanometers thick. In some instances the layer of imprintable medium 34 may be significantly thicker than this, for example if only a single layer is to be imprinted on the substrate 32 and the imprintable medium is a functional material.

An optical source 36 is located above the template holder 31. The optical source is configured to provide a high energy pulsed beam, and may for example be an Nd:YAG laser. Both the imprint template 30 and the template holder 31 are fabricated from materials which are substantially transparent to the wavelength of illumination provided by the source 36. For example, where the source 36 is a Nd:YAG laser which produces light at approximately 1064 nanometers (infrared), the imprint template 30 and template holder 31 may be fabricated from quartz.

Use of an embodiment of the invention is illustrated schematically in FIGS. 4b to 4e. Referring first to FIG. 4b, the imprint template 30 is lowered until lowermost portions of the pattern provided on the imprint template are in contact with the imprintable medium 34. The optical source 36 then emits a beam of light 37 which passes through the template holder 31 and imprint template 30, and is incident upon the metal layer 35. The layer of metal 35 absorbs the beam of light 37, and rapidly becomes hot. This may occur within a few microseconds. The portion of the metal layer 35 which is in contact with the imprintable medium 34 transfers heat to the imprintable medium, which heats up accordingly. The beam of light 37 is sufficiently broad to ensure that all of those parts of the metal layer 35 which are in contact with the imprintable medium 34 are illuminated by the beam. The imprintable medium 34 heats up rapidly, to a temperature which is above its glass transition temperature. Once this has occurred, the imprintable medium 34 is in a fluid state. In an alternative or additional arrangement, the beam of light 37 is also incident on the metal layer 35 before it comes into contact with the imprintable medium 34. A disadvantage of this approach is that it might heat the metal layer 35 more than is necessary.

Referring to FIG. 4c, once the imprintable medium 34 has heated up beyond the glass transition temperature, the imprint template 30 is pushed downwards into the imprintable medium. The imprintable medium 34 flows into the pattern on the lowermost surface of the template 30. This occurs quickly and easily, since the imprintable medium 34 is in a fluid state. In an alternative approach, the imprint template 30 may be pushed downwards (e.g., with a continuous force on the imprint template) into the imprintable medium 34 before the imprintable medium is fully heated, with the effect that the imprint template moves into the imprintable medium (which flows into the pattern) immediately that the imprintable medium passes beyond the glass transition temperature. This has an advantage that it may provide a more efficient transfer of heat from the metal layer 35 to the imprintable medium 34, since the area of contact between the metal layer 35 and the imprintable medium 34 is increased.

Referring to FIG. 4d, the light source 36 is turned off (or the output from the light source is blocked), while the imprint template 30 remains in place. The metal layer 35 on the imprint template 30, and the imprintable medium 34, rapidly cool down. The temperature of the imprintable medium 34 falls below the glass transition temperature, so that it returns to a solid form and is no longer free to flow beneath the imprint template 30. The imprint template 30 is then raised upwards away from the imprintable medium 34, as shown in FIG. 4e. The imprintable medium 34 retains the pattern imprinted by the imprint template 30.

The moment at which light source 36 is turned off (or blocked) may be determined from trial and error, or from monitoring the progress of the imprint process. In one example, the light source 36 may be turned off (or blocked) after the imprintable medium 34 has fully flowed into the pattern on the imprint template 30. In another example, the light source 36 may be turned off (or blocked) before that point, since the imprintable medium 34 may remain in the fluid state (provided that it is hot enough) for a period of time after the light source 36 has been turned off (or blocked).

An advantage of the embodiment of the invention is that the metal layer 35 absorbs the light beam 37 efficiently, and thus heats up very quickly. United States patent application publication no. US 2004/0046288 discloses an imprint method in which a laser is used to provide heating to an imprintable medium provided on a substrate. This arrangement suffers from a disadvantage that the imprintable medium is not an efficient absorber of the laser radiation, and therefore may be slow to absorb energy and heat up to the glass transition temperature. An embodiment of the present invention is more efficient, and therefore faster, because the beam 37 is efficiently absorbed by the metal layer 35, and heat from the metal layer is efficiently transferred to the imprintable medium 34.

A further advantage of an embodiment of the invention is that energy is transferred efficiently to the imprintable medium 34 rather than passing into the substrate 32. In United States patent application publication no. US 2004/0046288, since the illumination beam is not efficiently absorbed by the imprintable medium, the majority of energy from the illumination beam passes into the substrate and causes heating of the substrate. This is not desired because it may cause localized heating of the substrate, which may in turn cause the substrate to distort. An embodiment of the invention transfers heat efficiently from the illumination beam 37 to the metal layer 35, and transfers heat efficiently from the metal layer 35 to the imprintable medium 34. Thus, heat is transferred efficiently from the illumination beam 37 to the imprintable medium 34, without instead passing to the substrate 32.

Another advantage of an embodiment of the invention is that heat transfer within the metal layer 35 is very quick (i.e., heat will be transferred quickly from a high temperature region to a low temperature region of the metal layer). This means that any inhomogeneity in the beam 37 used to heat the layer of metal 35 is averaged out within the layer of metal. All points on the layer of metal 35 will have substantially the same temperature, and so will cause heating of the imprintable medium 34 at substantially the same rate. This is advantageous compared with the arrangement disclosed in United States patent application publication no. US 2004/0046288, where heat from a laser beam is directly transferred to an imprintable medium. In this arrangement, any inhomogeneity in the laser beam (or inhomogeneity in the structure of layers already present on the substrate) cause the imprintable medium to heat up at different rates at different locations. This means in turn that different areas of the imprintable medium will reach the glass transition temperature at different times, and this will lead to a non-optimal imprint of an imprint template into the imprintable medium.

Although an embodiment of the invention has been described as having a light source 36 which is a Nd:YAG laser, it will be appreciated that other lasers may be used. For example, a laser which generates light in the visible wavelength spectrum or in the ultraviolet wavelength spectrum may be used. It is not essential that the source is a laser, and any other suitable source may be used. Although an embodiment of the invention is described as having a quartz imprint template 30 and template holder 31, it will be appreciated that the imprint template and template holder may be fabricated from other suitable materials, for example silicon. The material is selected to be transparent at the wavelength emitted by the light source 36.

The light source 36 may include a beam expander (not illustrated) which is arranged to expand the beam from the laser so that it is sufficiently large to illuminate the entirety of the pattern provided on the imprint template 30.

An embodiment of the invention may be used to fabricate any useful structure, for example, an integrated circuit, a MEMs device, etc. An embodiment of the invention may be used to fabricate a pre-structure on a hard disk to be used for data storage. A pre-structure is used to ensure that a hard disk stores data efficiently, and comprises very small structures provided in a working layer which is located between an aluminum base of the hard disk and a magnetic material provided on an upper surface of the hard disk. These very small structures may be efficiently fabricated using an embodiment of the invention. Similarly, an embodiment of the invention may be used to provide tracks on the hard disk.

The metal layer 35 may be deposited on the template 30, for example, by using electroplating. Although an embodiment of the invention is described as having a metal layer 35 formed from nickel, chromium or aluminum, any other suitable metal may be used. Metals are provided instead of other compounds because in general they do not melt at high temperatures, and can be conveniently deposited onto the imprint template 30. Metal also has an advantage that it may be heated quickly and efficiently using an illumination beam. Any other suitable layer of heat absorbing material could be used instead of metal. For example, dielectric material could be used. The dielectric should be an efficient absorber of energy.

The description of the embodiment of the invention is in relation to an imprintable medium which is thermoplastic. An embodiment of the invention may alternatively be used with an imprintable medium which is thermosetting. Where a thermosetting imprintable medium is used, the beam 37 is used to increase the temperature of the imprintable medium 34 when the imprint template 30 is in an imprinting position (for example as shown in FIG. 4c). Increasing the temperature of the imprintable medium 34 causes it to set, so that the pattern imprinted by the imprint template 30 remains after the imprint template has been removed.

While specific examples of the invention have been described above, it will be appreciated that the present invention may be practiced otherwise than as described. The description is not intended to limit the invention.

1. A lithographic apparatus comprising an imprint template and a substrate table configured to hold a substrate, the imprint template having a patterned surface, a layer of heat absorbing material provided on the patterned surface of the imprint template.

2. The apparatus according to claim 1, wherein the heat absorbing material is metal.

3. The apparatus according to claim 2, wherein the metal comprises nickel, chromium or aluminum.

4. The apparatus according to claim 1, wherein the layer of heat absorbing material is more than ten nanometers thick.

5. The apparatus according to claim 1, wherein the layer of heat absorbing material is more than one hundred nanometers thick.

6. The apparatus according to claim 1, wherein the layer of heat absorbing material is less than one micrometer thick.

7. The apparatus according to claim 1, wherein the apparatus further comprises a radiation source arranged to emit radiation at a wavelength which will be absorbed by the layer of heat absorbing material.

8. The apparatus according to claim 7, wherein the imprint template is transparent at the wavelength of radiation emitted by the radiation source, with the exception of the layer of heat absorbing material.

9. The apparatus according to claim 7, wherein the imprint template is held in a template holder, the template holder being transparent at the wavelength of radiation emitted by the radiation source.

10. The apparatus according to claim 7, wherein the heat absorbing material is metal.

11. An imprint template having a surface with a pattern configured to be imprinted into an imprintable medium, the imprint template comprising a layer of heat absorbing material located over the pattern.

12. The template according to claim 11, wherein the imprint template is formed from a material which is transparent to infrared, visible, or ultraviolet radiation.

13. The template according to claim 11, wherein the heat absorbing material is metal.

14. The template according to claim 13, wherein the metal comprises nickel, chromium or aluminum.

15. The template according to claim 11, wherein the layer of heat absorbing material is more than ten nanometers thick.

16. The template according to claim 11, wherein the layer of heat absorbing material is more than one hundred nanometers thick.

17. The template according to claim 11, wherein the layer of heat absorbing material is less than one micrometer thick.

18. The template according to claim 11, wherein the layer of heat adsorbing material is configured to absorb radiation.

19. The template according to claim 18, wherein the imprint template is transparent to the radiation, with the exception of the layer of heat absorbing material.

20. The template according to claim 18, wherein the heat absorbing material is metal.

21. A method of imprint lithography, the method comprising positioning an imprint template on a layer of imprintable medium on a substrate, such that a layer of heat absorbing material provided on a patterned surface of the imprint template is in contact with the imprintable medium, illuminating the layer of heat absorbing material with radiation such that the layer of heat absorbing material is heated up and transfers heat to the imprintable medium, and pressing the imprint template into the imprintable medium.

22. The method according to claim 21, further comprising stopping the radiation after the imprint template has been pressed into the imprintable medium.

23. The method according to claim 21, comprising illuminating the layer of heat absorbing material with the radiation prior to pressing the imprint template against the imprintable medium.

24. The method according to claim 21, further comprising pressing the imprint template against the imprintable medium prior to illuminating the layer of heat absorbing material with the radiation.

25. The method according to claim 21, wherein the heat absorbing material is metal.
